(19) United States
(12) Patent Application Publication
(10) Pub. No.: US 2022/0120553 A1
(43) Pub. Date: Apr. 21, 2022

(54) ANGULAR DISPLACEMENT MEASURING DEVICE

(71) Applicant: Wu Chunna, Longyan City (CN)

(72) Inventor: Wu Chunna, Longyan City (CN)

(21) Appl. No.: 17/076,344

(22) Filed: Oct. 21, 2020

(51) Int. Cl. G01B 7/30; G01B 7/00

(52) U.S. Cl. CPC G01B 7/30; G01B 7/003

(57) ABSTRACT

The application provides an angular displacement measuring device, which uses an absolute linear grating ruler to measure angular displacement, including an absolute linear grating scale with absolute tracks, two opposite ends of the linear grating scale are connected to form a ring, which ring is tightly wound on a motor shaft, a first read head and a second read head positioned in two different positions along the circumference of the ring, for reading a track value on the ring and sending the track value to a data processing unit. The application also provides a method for measuring angular displacement of the motor shaft using the aforementioned angular displacement measuring device.

### TECHNICAL FIELD

The present application relates to an angular displacement measuring device.

### BACKGROUND

In the prior art, rotary angles or angular displacements are typically measured by an encoder with circular grating. A circular grating is formed by etching tracks on a glass disc, and an encoder comprising circular grating can be used to measure rotary angles or angular displacements. However, etching tracks with high precision on a glass disc requires relatively high investment and difficult process.

### SUMMARY

The present application provides an angular displacement measuring device, which utilizes an absolute linear grating scale to achieve the function of a circular grating, with simple process and low cost, and the technical solutions are as follows:

An angular displacement measuring device, including a linear grating scale, two opposite ends of the linear grating scale are connected to form a ring, which ring is tightly wound on a motor shaft, a first read head and a second read lead positioned in two different positions along the circumference of the ring, for reading a track value on the ring and sending the track value to a data processing unit.

Further, said linear grating scale is provided with absolute tracks.

Further, said first read head and second read head are positioned oppositely along the circumference of the ring.

The present application also provides a method of measuring angular displacement using said angular displacement measuring device, comprising the steps of:

selecting a linear grating scale of suitable length, two opposite ends of which linear grating scale are connected to form a ring, which ring is tightly wound on a motor shaft and on which ring there exists a joint position;

providing a first read head and a second read head in two different positions along the circumference of the ring;

the first read head detecting a first track value and the second read head detecting a second track value when the motor shaft rotates;

the first read head sending the first track value and the second read head sending the second track value to a data processing unit;

the data processing unit processes the first track value and the second track value and outputs a track value as follows:

when neither the first read head nor the second read head passes through the joint position, the difference between the first track value and the second track value is a constant value, which can be determined according to the position of the first read head and the second read head, in which case the first track value and the second track value are both accurate track values, and the data processing unit outputs the first track value or the second track value for calculating the angular displacement of the motor shaft;

when either one of the first raid head and the second read head passes through the joint position, due to the existence of a gap at the joint position, the track value detected by the read head passing through the joint position is less than the actual track value, at this time the difference between the first track value and the second track value will be changed, when the difference between the first track value and the second track value changes, the larger track value is accurate, and the data processing unit discards the smaller one and outputs the larger one for calculating the angular displacement of the motor shaft.

The beneficial effect of the present invention is that it realizes the measurement of angular displacement by means of a linear grating scale, with a simple process and accurate measurement results.

### BRIEF DESCRIPTION OF THE DRAWINGS

FIG. 1 show s a schematic diagram of the angular displacement measuring device provided by an embodiment of the present application; and

FIG. 2 shows a schematic diagram of the modules of the angular displacement measuring device provided by an embodiment of the present application.

### DETAILED DESCRIPTION OF THE EMBODIMENTS

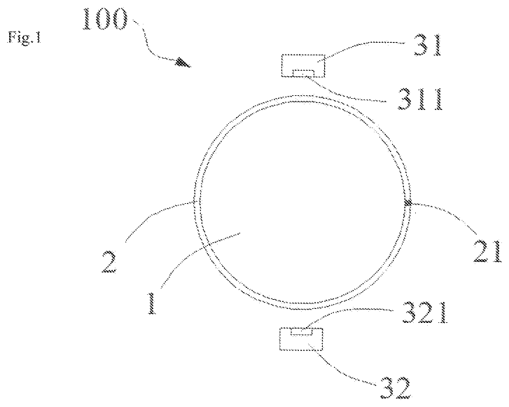

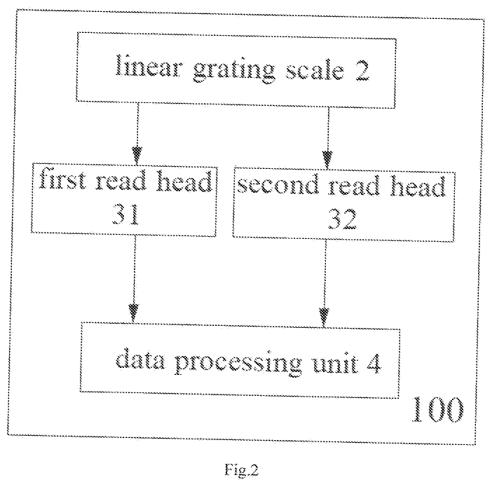

Referring to FIGS. 1 and 2, a schematic diagram of an angular displacement measuring device 100 in use according to an embodiment of the present invention, and a schematic diagram of its modules are provided.

The angular displacement measuring device 100 includes a linear grating scale 2, for example, the linear grating scale 2 can be an absolute linear grating scale provided with absolute tracks. Two opposite ends of the linear grating scale 2 are connected to form a ring, which ring is tightly wound on a motor shaft 1 and on which ring there exists a joint position 21. A first read head 31 and a second read head 32 are positioned in two different positions along the circumference of the ring, for reading a track value on the ring and sending the track value to a data processing unit 4. In the embodiment shown in FIG. 1, the first read head 31 and the second read head 32 are positioned oppositely along the circumference of the ring.

In one embodiment, the angular displacement measuring device 100 is used to measuring angular displacement as follows.

A linear grating scale 2 of suitable length is selected, two opposite ends of which linear grating scale 2 are connected to form a ring, which ring is lightly wound on a motor shaft 1 and on which ring there exists a joint position 21;

A first read head 31 and a second read head 32 are provided in two different positions along the circumference of the ring, and in the embodiment shown in FIG. 1, the first read head 31 and the second read head 32 are positioned oppositely along the circumference of the ring.

It can be known from the prior art that there are tracks provided on the linear grating scale 2, and the first read head 31 detects a first track value v1 and the second read head 32 detects a second track value v2 when the motor shaft 1 rotates, and the first read head 31 sends the first track value v1 and the second read head 32 sends the second track value v2 to a data processing unit 4.

In the embodiment shown in FIG. 1, in the initial position shown in FIG. 1, the data processing unit 4 calculates the absolute value of the difference Δv between the first track value v1 and the second track value v2,Δv=|v1−v2|, which is a constant value and can be determined according to the position of the first read head 31 and the second read head 32, at this time and when neither the first read head 31 nor the second read head 32 passes through the joint position 21, the absolute value of the difference between the first track value 31 and the second track value 32 is a constant value, in which ease the first track value v1 and the second track value v2 are both accurate track values, and the data processing unit outputs the first track value v1 or the second track value v2 for calculating the angular displacement of the motor shaft 1.

As the motor shaft 1 rotates, when either one of the first read head 31 and the second read head 32 passes through the joint position 21, due to the existence of a gap at the joint position 21, the track value detected by the read head passing through the joint position 21 is less than the actual track value, at this time the absolute value of the difference between the first track value v1 and the second track value v2 will be changed, i.e., Δv′=|v1−v2|≠Δv, when the absolute value of the difference between the first track value v1 and the second track value v2 changes, the larger track value is accurate, and the data processing unit 4 compares the absolute value of the first track value v1 and the absolute value of the second track value v2, and discards the smaller one and outputs the larger one for calculating the angular displacement of the motor shaft 1.

We claim:

1. An angular displacement measuring device, characterized in that: including a linear grating scale, two opposite ends of the linear grating scale are connected to form a ring, which said ring is tightly wound an a motor shaft, a first read head and a second read head positioned in two different positions along a circumference of the ring, for reading a track value on the ring and sending the track value to a data processing unit.

2. The angular displacement measuring device according to claim 1, characterized in that: said linear grating scale is provided with absolute tracks.

3. The angular displacement measuring device according to claim 1, characterized in that: said first read head and said second read head are positioned oppositely along the circumference of the ring.

4. A method of measuring angular displacement using the angular displacement measuring device according to claim 1, characterized in that: comprising the steps of:
selecting a linear grating scale of suitable length, two opposite ends of which linear grating scale are connected to form a ring, which ring is tightly wound on a motor shaft;
providing a first read head and a second read head in two different positions along circumference of the ring;
the first read head detecting a first track value and the second read head detecting a second track value when the motor shaft rotates, and the first read head sending the first track value and the second read head sending the second track value to a data processing unit;
the data processing unit calculating an absolute value of a difference between the first track value and the second track value, when the absolute value is equal to a preset value, and the data processing unit outputs the first track value or the second track value, and when the absolute value is not equal to the preset value, the data processing unit compares the absolute value of the first track value and the absolute value of the second track value and outputs a larger one.

5. The method of measuring angular displacement according to claim 4, characterized in that: the preset value can be determined according to the position of the first read head and the second read head.
